(19) United States
(12) Patent Application Publication
(10) Pub. No.: US 2004/0191737 A1
(43) Pub. Date: Sep. 30, 2004

(54) Process for curing psychosis in humans

(76) Inventor: Mark Doehner, Carlsbad, CA (US)

Correspondence Address: MARK DOEHNER, 5183 LOS ROBLES DRIVE, CARLSBAD, CA, 92008, US

(21) Appl. No.: 10/395,411

(22) Filed: Mar. 25, 2003

(51) Int. Cl. G09B 19/00

(52) U.S. Cl. 434/236

(57) ABSTRACT

A process of curing psychosis comprising the steps of having a therapist guide the patent through the steps of directing the patient to try to recall when the last time in their life they felt “happy” or felt “good” about “things in general”; directing the patient to try to remember anything that occurred that seemed “strange” or “odd” at the time; directing the patient to imagine what could have happened to someone else if they were in one of the above situations to insure the patient comes to the realization that he/she has had a traumatic experience; and, directing the patient to select a place of complete privacy to which he/she can go when feelings of sadness begin to be felt (either sad mood or specific sad event) to create in the patient the experience of re-integrative polarization convulsion.

### BACKGROUND OF THE INVENTION

1. Field of the Invention

This invention pertains to the Pathologies of the human mind. More particularly, it pertains to the condition known as “psychosis” and to a process for the primary recovery from this condition.

2. Description of the Prior Art

“Psychosis” is defined as a major mental disorder in which the personality is very seriously disorganized and contact with reality is usually impaired. Psychoses are of two sorts: (a) functional—characterized by a lack of apparent organic cause, and principally of the schizophrenic or manic-depressive type, and (b) organic—characterized by a pathological organic condition such as brain damage or disease, metabolic disorders, etc.

Until now, there has been no cure for Psychosis—on y diagnosis and treatment. Treatments (therapy and/or medication) are not urative, but can only hope to diminish the major (active) symptoms that are observable in the early stages of the illness. The major difficulty with the long-term use of so-called “anti-psychotic” drugs is that there is a risk of permanent neurological damage and little is known regarding dosage management. These drugs are highly addictive and the brain's reaction to their withdrawal is often mistakenly diagnosed as a need to go back on them or increase the dosages. This phenomenon is described in detail in Dr. Peter Breggin's book “YOUR DRUG MAY BE YOUR PROBLEM”, published by Perseus, Reading, Mass. (1999) which had he been aware of the facts presented herein, may have titled it “YOUR DRUG MAY BE EXACERBATING YOUR PROBLEM”. Until now, these medications were the most advanced treatment available. In all fairness to everyone involved with their development and prescription, they were a tremendous advance over alternative methods of “treatment” such as physical restraint, electro-shock and lobotomy.

J. Allen Hobson, a psychiatry professor at Harvard Medical School and medical writer Jonathan Leonard in their new book “Out of its Mind” PSYCHIATRY IN CRISIS, published by Perseus, Cambridge Mass. (2001) contend that psychiatry suffers from a lack of public confidence with half the profession promoting humanistic therapies like counseling while the other half advocates drug based treatments. Neither side, the authors say, works well with the other. The result is that much about psychiatry has become dysfunctional and irrelevant. They argue for a complete revamping of mental health care in the United States, one that would emphasize a “neurodynamic” approach combining the latest in brain research, pharmaceuticals and classic therapeutic treatments. It is now time to incorporate the mind's ability to mend itself under the proper conditions (the process described in this patent) as the physical body mends itself under the proper conditions.

### Damage Assessment

Just prior to the onset of TSBD, the intense emotional stimulation that couldn't be expressed because of the TEPP survival condition were directed in either or both of two directions depending on the pre-disposition of the personality (directed outwardly toward the environment or inwardly toward the self). To the extent the suppressed emotions were directed inwardly toward the self, the damage forms the basis for guilt, low self-esteem and depression. To the extent the suppressed emotions were directed outwardly toward the environment, the damage forms the basis for baseline anxiety, and suppressed anger and hatred.

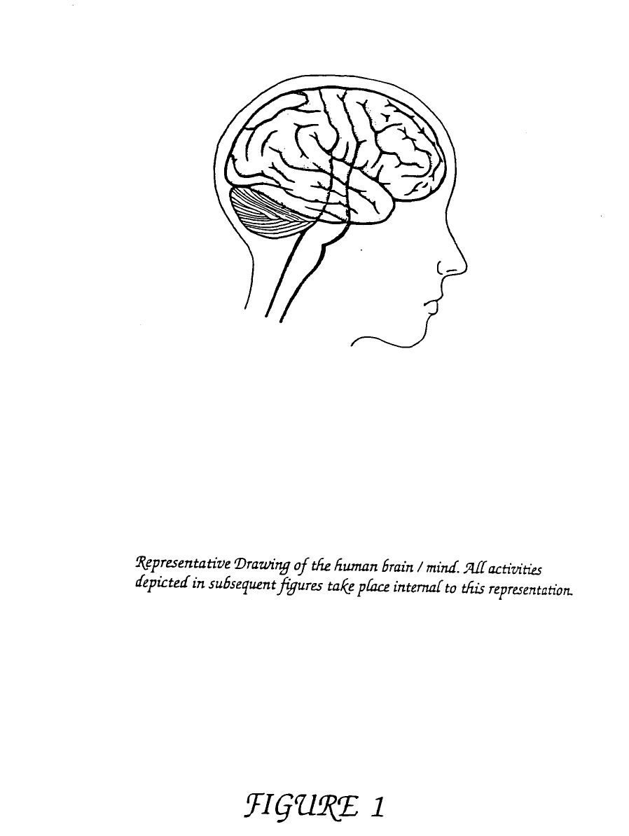

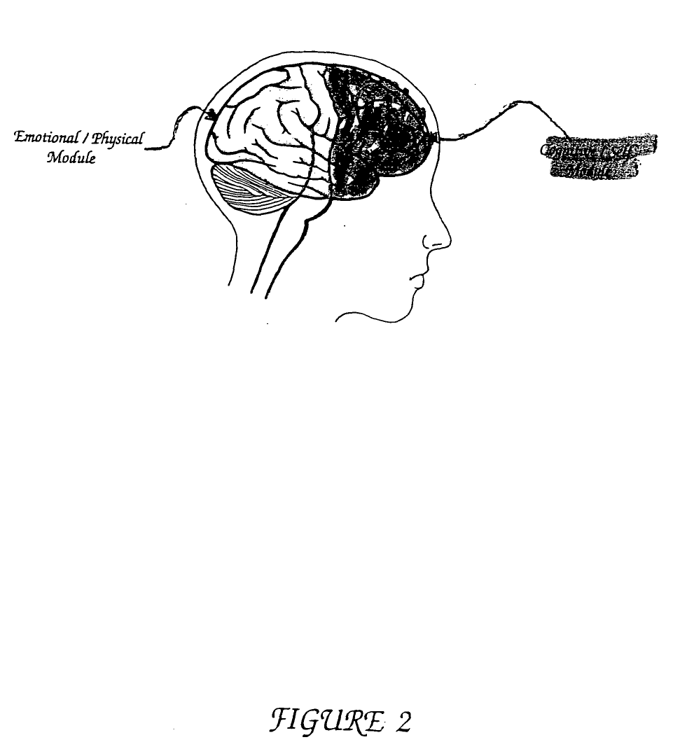

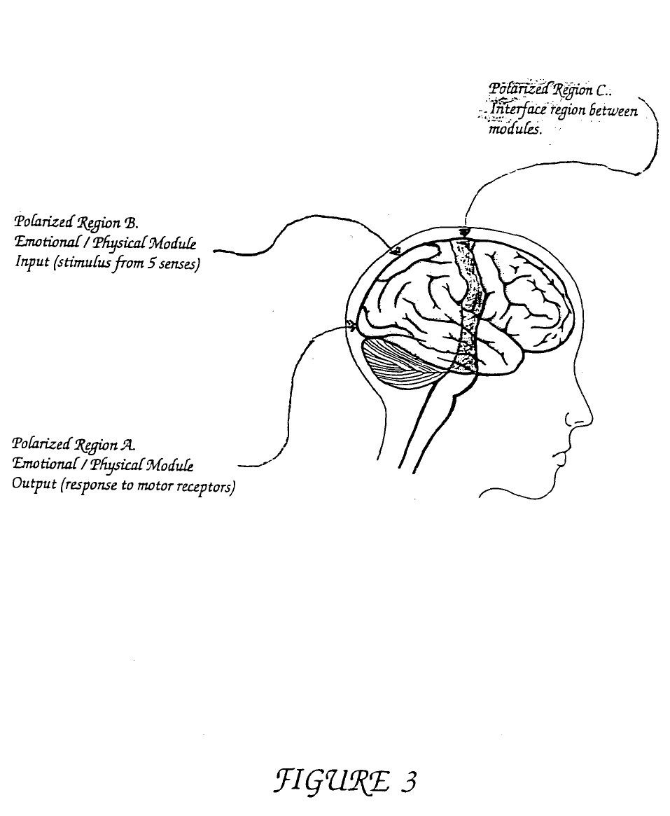

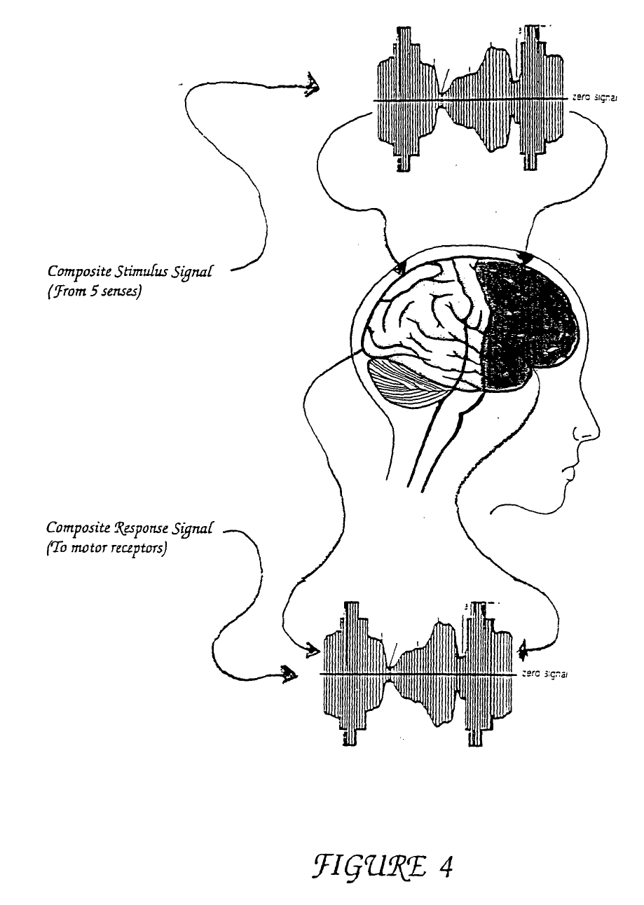

When the perception is one of safety (Watchdog detects stable buss conditions), the organism is left in a state of a partial “re-connect” of “self” and “body”. The regions between the cognitive and the emotional/physical modules are no longer totally disconnected but the signal processing properties of these inter-connect regions are negatively affected (poorly polarized) having gone from an “open circuit” state during TSBD to one of relatively high impedance upon cessation of the attack.—Reference FIG. 10.

The Following are Resulting Consequences to the Personality:

A secondary “personality” is developed to deal with the “outside world”. Refer to R. D. Laing's concept of the “False Self” in “The Divided Self”, published by Pantheon, 1969, or Harry Stack Sullivan's “System of Selves” in “The Interpersonal Theory of Psychiatry”, published by W.W. Norton & Company, New York—London, 1953. The primary or “true” self is relegated to observation and commentary, leaving the “False Self” to interact with other people. Because of this, the personality of the “true” self is in effect frozen in its development or at least development is greatly attenuated. Because the self is not fully participating in reality, is not fully profiting from experience.

It now requires a great deal of effort and a large allocation of the mind's “energy budget” to anticipate how one is going to respond in social situations as the “False Self's” responses are often seen by the “self” to be inadequate and must be modified or enhanced to be “acceptable” to the “self”. The self's criticism of the false self's social responses may manifest itself as audible hallucinations. Un-affected people routinely articulate their thoughts and actions without being aware of this “inner voice”.

In the person with high impedance interfaces, there is enough of a delay in signal propagation that their own “inner” voice appears to be coming from someplace else. This gives rise to a heightened sense of self-awareness and self-consciousness which results in considerable anxiety rendering even casual social interaction to be a chore to be endured (or avoided altogether).

Further consequences of the high impedance of the interface regions are the attenuation of both emotional stimulation and corresponding emotional response. This manifests itself as an apparent impoverishment of affect. Joy is impossible to be experienced, which may manifest as a lack of interest in once pleasurable activities. But joy is sensed in other people which gives rise to resentment and jealousy.

To go through life with these psychological handicaps and in constant emotional pain is bearable for only a relatively few people. Until now, there were only two forms of relief—temporary (medical “treatment” and/or substance “abuse”) and permanent (suicide).

### The Cognitive Methodologies Research Psycho-Physical Process for the Primary Recovery from Psychosis.

Note: No direct accessing of memory is possible due to SASA.

The cognitive module's ability to anticipate along with the ability to imagine will be utilized to “get around” the SASA function of the Watchdog.

### A) Triangulation:

The first task is for the patient to try to recall when the last time in their life they felt “happy” or felt “good” about “things in general”. This can be as general as a particular age (e g. 14). The patient should then try to narrow it down if possible. (e.g.; The summer right after he/she turned 14). Also helpful might be to ask family members and/or friends if they remember a time when (the patient) seemed “different” to them somehow or “not your usual self”. This process may take weeks or might be achieved in the first session. It cannot be rushed nor is there a need to.

Once the general time frame has been established, the next task is for the patient to try to remember anything that occurred that seemed “strange” or “odd” at the time (someone suddenly appearing from behind a tree and then just leaving). (note: frightening or painful memories cannot be remembered directly. Seconds after the onset of an attack, the events are not recorded as valid experience in memory—only the short period prior to the onset of TEPP are recorded as valid memory but these are held out of consciousness). Memory resumes “recording” after it is perceived that the danger is past. It can be thought of as if a camcorder was shut off just before a horrible event and turned back on after the horror was over. This phrase is successful when the patient is able to identify a “strange” experience and it's approximate time frame.

Example: The patient remembers walking through a wooded area and being startled by a stranger suddenly appearing from behind a tree and then leaving.

### B. Circumventing SASA and coming to “Realization”

The next task is for the patient to imagine what could have happened to someone else if they were in one of the above situations. (The key here is that the patient is not trying to remember anything directly that happened to himself herself). There does not exist even the realization that something bad had happened. The SASA mechanism is preventing this realization from entering conscious awareness (background “hyper-composite” signal).

The imagination is “allowed” (by SASA) to function because what is being imagined does not (yet) apply to the self.

The patient is encouraged to imagine all manner of scenarios with someone else as the “participant” as often as possible. This phase is successful when (spontaneously) one day the patient comes to the “realization” that he/she had been the victim of a traumatic experience. The patient will feel a deep sorrow. This will be followed by outrage and anger. Finally, there will be a deep resolve to get “oneself back again”.

### C) RPC

At this point the patient is “armed” to go through the Re-integrative Polarization Convulsion phase of recovery. That is, any sad event (loss of a job, death in the family) or simply a particularly sad mood will be able to “trigger” RPC.

It should be emphasized that the patient be completely alone when RPC is experienced. If anyone else is present, the patient will be too self-conscious to let RPC run its full course. The patient should be instructed to locate a private area of some kind (an attic, closet, garage, somewhere their car can be parked etc.) where he/she can go and be assured that they will be completely alone.

The patient should be informed of what to expect while experiencing RPC. The sadness is allowed to deepen until crying has begun. The crying will intensify to a deep bellowing that will seem disturbing to the patient but must be allowed to continue and run itself out. The patient will be observing this deep bellowing as first the “body” and then the “self” along with the “body”.

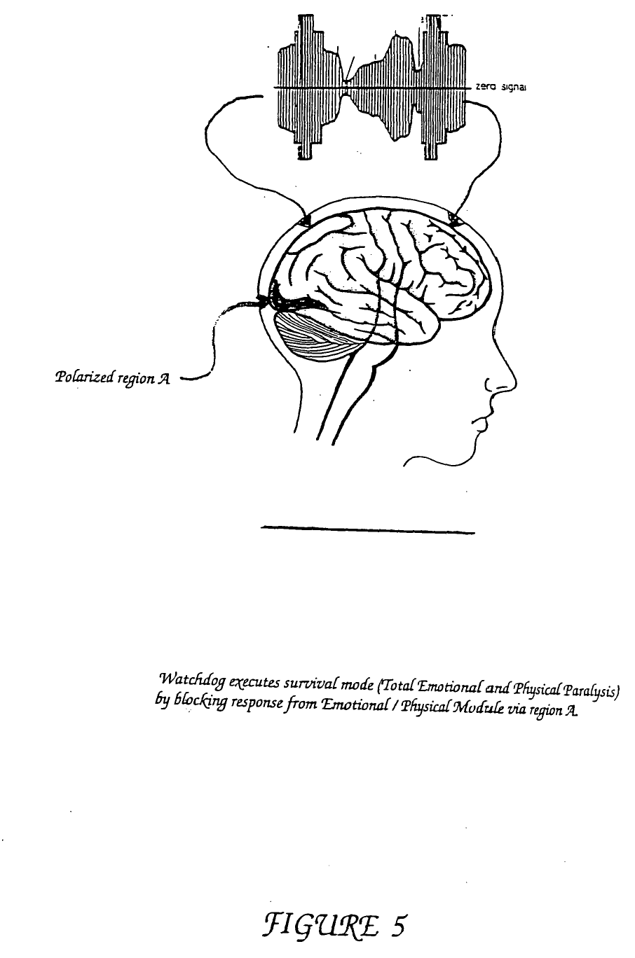

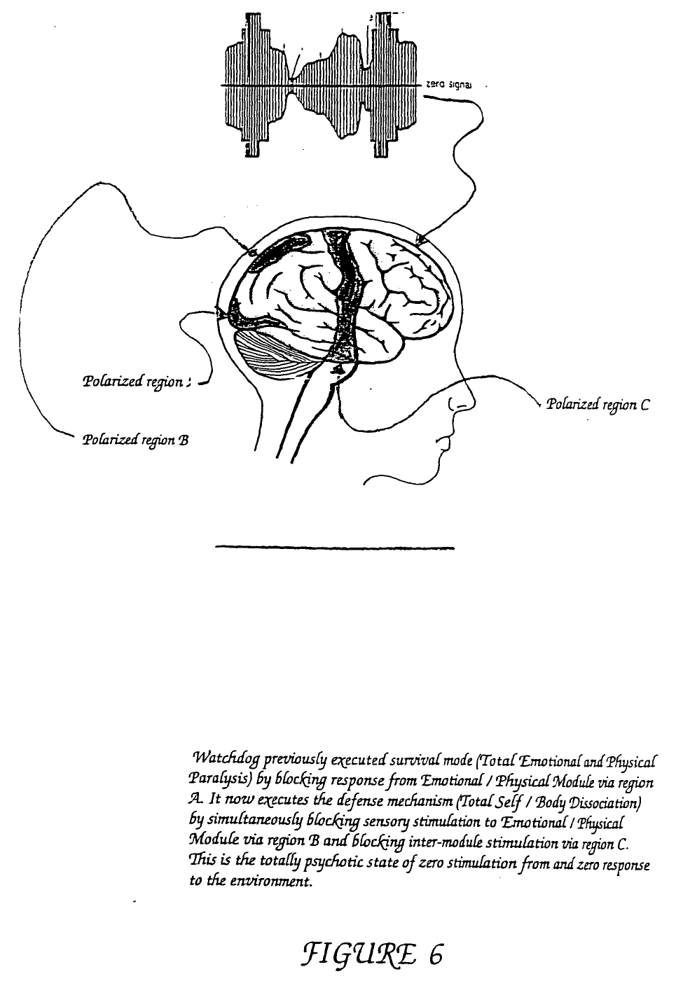

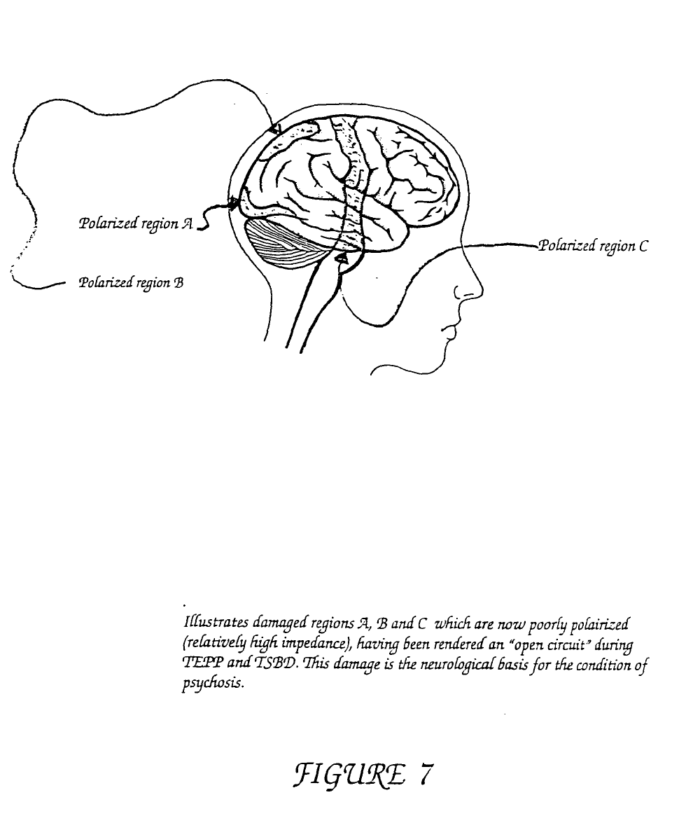

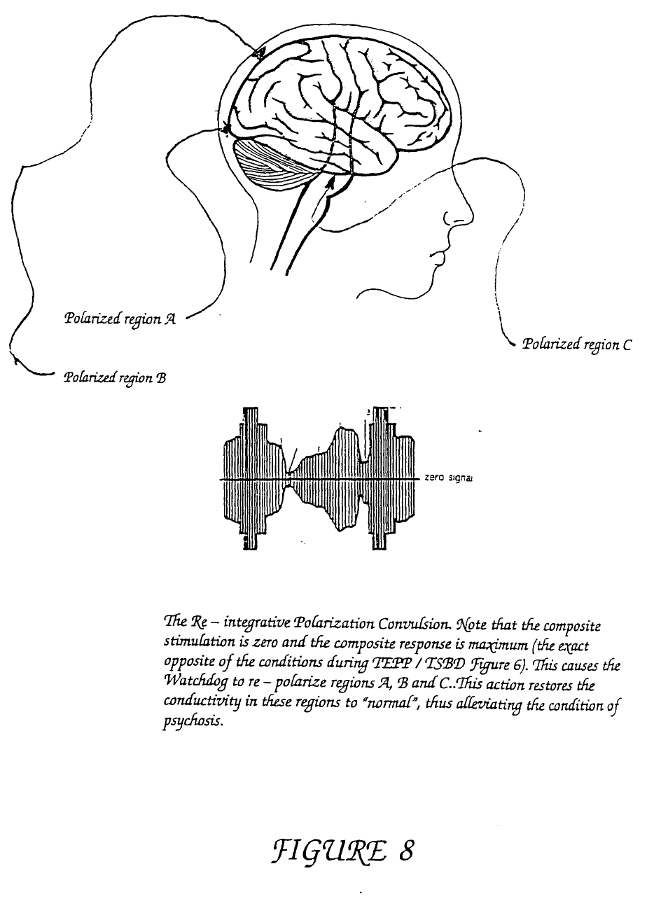

The key to the curative aspect of the RPC experience is that the conditions are the exact opposite of the conditions of the original attack (there is no external emotional stimulation but maximum emotional expression). The interface areas are subjected to stresses of the opposite electrochemical polarity, thus re-polarizing the regions. Ref. FIG. 11.

This is the extent of the CAR primary recovery process.

The “bones are now set”. Secondary recovery (the development of the arrested “true” personality and the decreasing dependency on the “false self” or “system of selves”) will occur spontaneously over time through every day social interaction. There will be occasional setbacks, but the patient must be nurtured and encouraged that with time the complete self will be restored. This will typically take several years and will vary greatly from patient to patient (the condition having been superimposed upon personalities of infinite variety and levels of development). The patient should also be encouraged that the levels of anxiety (both baseline and social interaction-specific) will gradually become reduced, as will depression (both baseline and mood amplified) over time. Research should be undertaken to develop processes to accelerate (under controlled conditions) this phase of recovery instead of relying upon unpredictable social environments. Until this occurs, the role of the therapist should be one of guidance and encouragement.

What is claimed is:

1. A process of curing psychosis comprising the steps of having a therapist guide the patent through the following steps:
a) directing the patient to try to recall when the last time in their life they felt “happy” or felt “good” about “things in general”;
b) directing the patient to try to remember anything that occurred that seemed “strange” or “odd” at the time;
c) directing the patient to imagine what could have happened to someone else if they were in one of the above situations to insure the patient comes to the realization that he/she has had a traumatic experience; and,
d) directing the patient to select a place of complete privacy to which he/she can go when feelings of sadness begin to be felt (either sad mood or specific sad event) to create in the patient the experience of re-integrative polarization convulsion.

2. The process of claim 1 wherein the step of directing the patient to try to remember anything that occurred that seemed “strange” or “odd” at the time is accomplished by hypnotizing of the patient.

3. The process of claim 1 wherein the step of directing the patient to try to remember anything that occurred that seemed “strange” or “odd” at the time is accomplished by the power of suggestion given to the patient.

4. The process of claim 1 wherein the step of directing the patient to try to remember anything that occurred that seemed “strange” or “odd” at the time is accomplished by EMDR.

5. The process of claim 1 wherein the step of directing the patient to try to remember anything that occurred that seemed “strange” or “odd” at the time is accomplished by therapist supplied scenarios given to the patient.

6. The process of claim 1 wherein the step of directing the patient to imagine what could have happened to someone else if they were in one of the above situations to insure the patient comes to the realization that he/she has had a traumatic experience is accomplished by hypnotizing of the patient.

7. The process of claim 1 wherein the step of directing the patient to imagine what could have happened to someone else if they were in one of the above situations to insure the patient comes to the realization that he/she has had a traumatic experience is accomplished by the power of suggestion given to the patient.

8 The process of claim 1 wherein the step of directing the patient to imagine what could have happened to someone else if they were in one of the above situations to insure the patient comes to the realization that he/she has had a traumatic experience is accomplished by EMDR.

9. The process of claim 1 wherein the step of directing the patient to imagine what could have happened to someone else if they were in one of the above situations to insure the patient comes to the realization that he/she has had a traumatic experience is accomplished by therapist supplied scenarios given to the patient.

10. The process of claim 1 wherein the step of directing the patient to select a place of complete privacy to which he/she can go when feelings of sadness begin to be felt (either sad mood or specific sad event) to create in the patient the experience of re-integrative polarization convulsion is accomplished by therapist suppling media about sadness such as a sad story.

11. The process of claim 1 wherein the step of directing the patient to select a place of complete privacy to which he/she can go when feelings of sadness begin to be felt (either sad mood or specific sad event) to create in the patient the experience of re-integrative polarization convulsion is accomplished by therapist suppling media about sadness such as sad music.

12. The process of claim 1 wherein the step of directing the patient to select a place of complete privacy to which he/she can go when feelings of sadness begin to be felt (either sad mood or specific sad event) to create in the patient the experience of re-integrative polarization convulsion is accomplished by therapist suppling a sad movie for the patient to watch.

13. The process of claim 1 wherein the step of directing the patient to select a place of complete privacy to which he/she can go when feelings of sadness begin to be felt (either sad mood or specific sad event) to create in the patient the experience of re-integrative polarization convulsion is accomplished by therapist discussing with the patient the death of a family friend, a close personal friend, or a previous lived one.

14. The process of claim 1 wherein the step of directing the patient to select a place of complete privacy to which he/she can go when feelings of sadness begin to be felt (either sad mood or specific sad event) to create in the patient the experience of re-integrative polarization convulsion is accomplished by therapist having the patient recall the break-up of a previous romance.

15. The process of claim 1 wherein the step of directing the patient to try to remember anything that occurred that seemed “strange” or “odd” at the time is accomplished by hypnotizing of the patient and the step of directing the patient to imagine what could have happened to someone else if they were in one of the above situations to insure the patient comes to the realization that he/she has had a traumatic experience is accomplished by the power of suggestion given to the patient.

16. The process of claim 1 wherein the step of directing the patient to try to remember anything that occurred that seemed “strange” or “odd” at the time is accomplished by hypnotizing of the patient and the step of directing the patient to imagine what could have happened to someone else if they were in one of the above situations to insure the patient comes to the realization that he/she has had a traumatic experience is accomplished by EMDR.

17. The process of claim 1 wherein the step of directing the patient to try to remember anything that occurred that seemed “strange” or “odd” at the time is accomplished by hypnotizing of the patient and the step of directing the patient to imagine what could have happened to someone else if they were in one of the above situations to insure the patient comes to the realization that he/she has had a traumatic experience is accomplished by therapist supplied scenarios given to the patient.

18. The process of claim 1 wherein the step of directing the patient to try to remember anything that occurred that seemed “strange” or “odd” at the time is accomplished by hypnotizing of the patient and the step of directing the patient to select a place of complete privacy to which he/she can go when feelings of sadness begin to be felt (either sad mood or specific sad event) to create in the patient the experience of re-integrative polarization convulsion is accomplished by therapist suppling media about sadness such as a sad story.

19. The process of claim 1 wherein the step of directing the patient to try to remember anything that occurred that seemed “strange” or “odd” at the time is accomplished by hypnotizing of the patient and the step of directing the patient to select a place of complete privacy to which he/she can go when feelings of sadness begin to be felt (either sad mood or specific sad event) to create in the patient the experience of re-integrative polarization convulsion is accomplished by therapist suppling media about sadness such as sad music.

20. The process of claim 1 wherein the step of directing the patient to try to remember anything that occurred that seemed “strange” or “odd” at the time is accomplished by hypnotizing of the patient and the step of directing the patient to select a place of complete privacy to which he/she can go when feelings of sadness begin to be felt (either sad mood or specific sad event) to create in the patient the experience of re-integrative polarization convulsion is accomplished by therapist suppling a sad movie for the patient to watch.
